(19) United States
(12) Patent Application Publication
(10) Pub. No.: US 2026/0126134 A1
(43) Pub. Date: May 7, 2026

(54) PIPE HANGER SLEEVE

(71) Applicant: Delta Machine & Ironworks, LLC, Baton Rouge, LA (US)

(72) Inventor: Martin Schutte, Lake Charles, LA (US)

(21) Appl. No.: 19/377,749

(22) Filed: Nov. 3, 2025

Related U.S. Application Data
(60) Provisional application No. 63/715,611, filed on Nov. 3, 2024.

(51) Int. Cl. F16L 3/10

(52) U.S. Cl. CPC F16L 3/1091

(57) ABSTRACT

A hanger sleeve positioned within a pipe hanger clamp for supporting an enclosed piping segment. The hanger sleeve has an interior wall surface with a plurality of inwardly projecting lobes which create a plurality of valleys with flow channels around the periphery of the piping segment to be supported. The valleys collect fluids and condensation created around the pipe hanger clamp and the piping segment to be supported which drain from the flow channels away from the hanger sleeve and its associated pipe clamp and piping segment.

### CROSS REFERENCE TO RELATED APPLICATIONS

The present invention derives priority from U.S. Provisional Ser. No. 63/715,611, filed Nov. 3, 2024, the entirety of which is incorporated herein by reference.

### FIELD OF INVENTION

The present invention relates to pipe hangers and pipe clamps for supporting metal pipes from a support structure and, more particularly, to a sleeve having projecting lobes with associated channels or galleries for the removal of water or collected condensate to prevent corrosion.

### BACKGROUND OF THE INVENTION

Piping systems with associated piping are utilized to convey fluids in a variety of industrial, chemical, commercial, oil and gas, marine, and public works facilities. Such fluids may be liquids, gases, and sludge including process chemicals, water, steam and combinations thereof and such fluids may be conveyed at a variety of temperatures, pressures, and velocities.

Pipe hangers are often integral components of piping systems and are utilized to suspend spans of piping from overhead support structures such as support beams. Pipe hangers are often provided with clamps that fit tightly around a piping segment of a piping system. Such piping systems and associated piping segments and pipe hangers are often installed and used in harsh environments where the components are subjected to water, salts, chemicals, and condensation.

The collection of such water, salts, chemicals, and condensation around the pipe hangers and associated piping due to such environments enhances the likelihood of corrosion of the system piping and its associated pipe hangers and supports. Such corrosion often results in the degradation of the piping system, its associated piping, its hangers which may ultimately result in a failure of the piping system and the creation of hazardous situations.

Millions of dollars are spent each year to inspect, repair, and replace damaged piping and pipe hangers of such piping systems. Due to the risk of such failure, the piping system, and its associated piping, pipe hangers, and pipe support structures must be inspected regularly to assess the integrity of the piping system in order to predict and prevent the occurrence of piping system failure.

Prior art pipe hangers which are known to the present inventor do not sufficiently minimize the collection of water, salts, chemicals, and condensation around the pipe hangers and associated piping and do not serve in reducing the incidence of corrosion and piping system failure.

From the above, it is apparent that there are improvements to pipe hangers of such piping systems that will assist in more effectively prevent the collection of water, salts, chemicals, and condensation around the pipe hangers and associated piping created by exposure of the piping systems to harsh environments.

It is also apparent that there is a need for a device to augment pipe hanger clamps that may be readily utilized in a piping system to reduce the collection of water, salts, chemicals, and condensation around the pipe hangers and associated piping in order to minimize the risk of corrosion and the time and expense associated with maintenance of the piping system.

### SUMMARY OF THE INVENTION

The present invention provides a pipe hanger sleeve to be utilized with a corresponding clamp of a pipe hanger for preventing corrosion around the associated piping segment being suspended or supported by the pipe hanger. The interior surface of the inventive hanger sleeve is provided with a plurality of projecting lobes, such as corrugations or ridges, which create a series of valleys around the interior of the hanger sleeve. The valleys so created serve as fluid galleries or flow channels for the evacuation of fluids away from around the pipe hanger clamp, and draining the fluids and condensation away from the hanger sleeve and associated piping segment.

The hanger sleeve of the present invention is preferably made of a hard but flexible composite polymer material, but any suitable material may be utilized, including polymer composites and metals. The hanger sleeve may be made as a belt-like one piece sleeve having an opening at one segment around its circumference so that the sleeve may be placed around a segment of piping. However, a device with two or more openings around its circumference is also within the scope of the present invention. When so placed, the hanger sleeve will be fixed in place around the piping segment by the corresponding pipe hanger clamp. Weep holes provided along the sleeve allow collected fluids and condensation which have collected in the flow channels to be evacuated, which also aids in the evacuation of the collected fluids from around the supported piping segment.

It is thought that a flexible one-piece hanger sleeve will be suitable for many pipe hanger applications. However, the hanger sleeve may be comprised of two or more arch-shaped independent sleeves or sleeve segments having the aforementioned lobes and associated fluid galleries or flow channels depending upon the size of the pipe hanger clamp and supported piping segment.

The pipe hanger sleeve of applicant's invention may be installed around a pipe with a supporting pipe hanger clamp during the initial construction of a piping system. The pipe hanger sleeve may also be installed around a pipe supported within a pipe hanger clamp of an existing piping system as an upgrade or modification of the existing pipe system.

### BRIEF DESCRIPTION OF DRAWINGS

FIG. 1 is a perspective view of a pipe hanger clamp and pipe segment fitted with the hanger sleeve of the present invention.

FIG. 2 is a perspective end view of a pipe hanger clamp and pipe segment fitted with the hanger sleeve shown in FIG. 1.

FIG. 3 is an inside view of the hanger sleeve shown in FIG. 1.

### DETAILED DESCRIPTION OF THE INVENTION

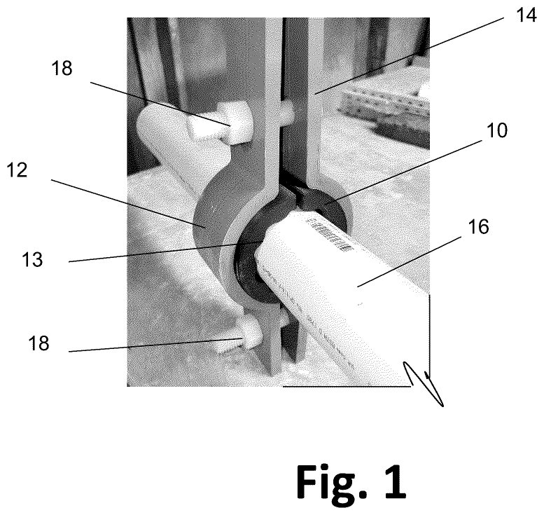

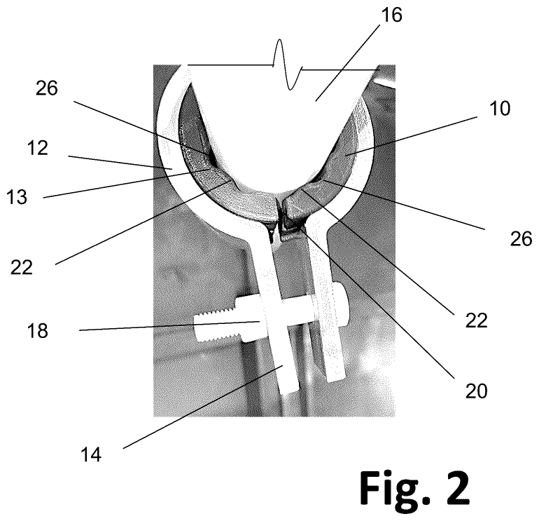

Referring to FIGS. 1 and 2, the hanger sleeve 10 of the present invention is shown utilized with a corresponding clamp 12 of a pipe hanger 14. The hanger sleeve 10 has an interior wall surface 13 that is provided with a plurality of inwardly projecting lobes 22, such as corrugations or ridges, which create a plurality of valleys 24 with flow channels 26 around the periphery of the piping segment 16.

The valleys 24 collect fluids and condensation created around and within the pipe hanger clamp 12 and the supported piping segment 16 which drain through the flow channels 26 away from the interior surface 13 of the hanger sleeve 10 and its associated pipe clamp 12 and piping segment 16. Draining the collected fluids from the interior of the pipe hanger clamp 12 and associated piping segment 16 serves to substantially prevent corrosion around the pipe hanger 12 and its associated piping segment 16.

The hanger sleeve 10 is preferably made of a hard but flexible composite polymer material but any suitable material may be utilized for the hanger sleeve 10 including polymer composites and metals.

The hanger sleeve 10 is shown as a belt-like one piece arch-shaped sleeve having an open segment 20 so that the hanger sleeve 10 may be placed around the piping segment 16. When so placed, the hanger sleeve 10 will be fixed in place between the piping segment 16 and the corresponding pipe hanger clamp 14 by fasteners such as a bolt and nut combination 18, or by other fasteners known in the art to hang pipes or other cylindrical conduits or fixtures.

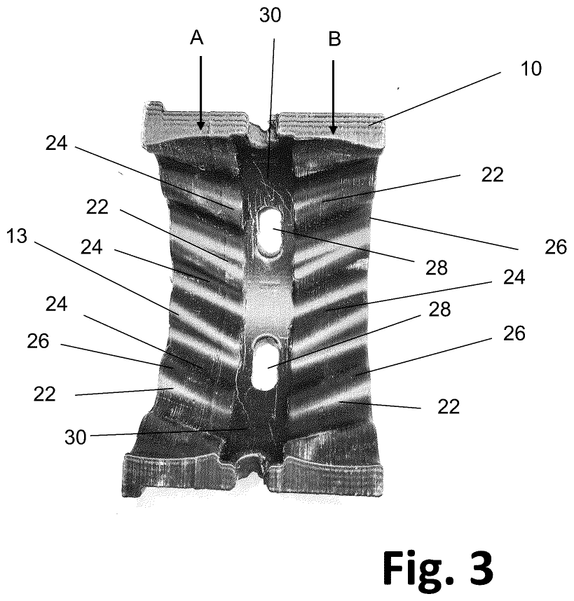

As shown in FIG. 3, in a preferred embodiment, a plurality of weep holes 28 may be provided along the length of the hanger sleeve 10. The weep holes 28 assist in the evacuation of the collected fluids and condensation that drain from the flow channels 26 around the supported piping segment 16. In a preferred embodiment, shown in FIG. 3, the hanger sleeve 10 may be provided with at least two sections, A and B, which are parallel and which each extend around the circumference of the interior surface 13. In a preferred embodiment, each of sections A and B includes a row of projecting lobes 22 which create corresponding valleys 24 with flow channels 26. Moreover, in a preferred embodiment as shown in FIG. 3, sections A and B are separated by an interior flow channel 30, in which one or more weep holes 28 are formed, such that fluids collected in flow channels 26 can drain either out to the side of the pipe hanger sleeve 10, or into the middle, and in either case will be evacuated from the sleeve 10, either by escaping from the side or being evacuated through one of the weep holes 28 in the center.

While a flexible one piece hanger sleeve 10 is thought suitable, the hanger sleeve 10 may be comprised of two or more arch-shaped independent sleeve segments, each having the aforementioned ridges or lobes 22 and associated fluid galleries or flow channels 26, with or without weep holes 28.

The pipe hanger sleeve 10 of applicant's invention may be installed around a piping segment 16 with a supporting pipe hanger clamp 14 during the initial construction of a piping system. The pipe hanger sleeve 10 may also be installed around a piping segment 16 supported within a pipe hanger clamp 12 of a pipe hanger 12 of an existing piping system as an upgrade or modification of the existing pipe system.

The upgrade of an existing piping system having piping segments 16 supported by pipe hanger clamps 12 of a pipe hanger 14 may be accomplished by first loosening or detaching the existing hanger clamp 12 previously positioned around a piping segment 16. Then by positioning a hanger sleeve 10 (or two or more segments comprising same) between the existing hanger clamp 12 and the supported piping segment 16. Then retightening the pipe hanger clamp 12 around the pipe hanger sleeve 10 and associated piping segment 16. Typically, no cutting, welding, or other attachment will be necessary.

As described herein, the present invention is particularly suited for use in connection with pipes which carry hot or cold fluids, or which are exposed to the elements, where condensation or other moisture attraction or seepage is more common. However, the present invention can be adapted for multiple uses, including on pipes of various cross-sectional shapes, by changing the shape of the interior surface of the sleeve, or by creating the sleeve out of a highly flexible material that will wrap around the external dimensions of conduits having multiple different shapes. Moreover, the present invention could be adapted for use in an application surrounding a conduit or other elongated device which does not carry fluid or gas, but which nevertheless attracts condensation by exposure to the elements or the like.

This application is therefore intended to cover any variations, uses, or adaptations of the invention using its general principles. Further, this application is intended to cover such departures from the present disclosure as come within known or customary practice in the art to which this invention pertains.

What is claimed is:

1. A pipe hanger clamp sleeve, comprising:
a. an arched-shaped sleeve having an interior wall; and
b. a plurality of inwardly projecting lobes around said interior wall, said projecting lobes creating a plurality of valleys having flow channels around said interior wall of said sleeve.

2. The pipe hanger clamp sleeve recited in claim 1 wherein said an arched-shaped sleeve is positioned with an arch-shaped clamp of a corresponding pipe hanger.

3. The pipe hanger clamp sleeve recited in claim 2 wherein a piping segment is positioned within said arch-shaped sleeve against said projecting lobes around said interior wall.

4. The pipe hanger clamp sleeve recited in claim 3 further comprising weep holes through said interior wall.

5. The pipe hanger clamp sleeve recited in claim 3 wherein said arch-shaped sleeve is comprised of polymer composites.

6. The pipe hanger clamp sleeve recited in claim 3 wherein said arch-shaped sleeve is comprised of metal.

7. In a pipe hanger having an arch-shaped clamp, pipe hanger clamp sleeve comprising:
a. an arched-shaped sleeve having an interior wall; and
b. a plurality of inwardly projecting lobes around said interior wall surface, said projecting lobes creating a plurality of valleys having flow channels around said interior wall of said sleeve;
c. at least one weep hole through said interior wall of said arch-shaped sleeve;
d. wherein said an arched-shaped sleeve is positioned with said arch-shaped clamp of said pipe hanger; and
e. wherein a piping segment is positioned within said arch-shaped sleeve against said projecting lobes around said interior wall surface of said arch-shaped sleeve.

8. In the pipe hanger having an arch-shaped clamp as recited in claim 7, said arched-shaped sleeve further comprising at least two rows of said projecting lobes creating a plurality of valleys having flow channels around said interior wall of said sleeve.
